(19) United States
(12) Patent Application Publication
(10) Pub. No.: US 2002/0082864 A1
(43) Pub. Date: Jun. 27, 2002

(54) Medical imaging system enhancement performance projection tool

(76) Inventors: Raymond J. Kelley, Waukesha, WI (US); Jack Oblein, Kenosha, WI (US); David M. Oreshack, Delafield, WI (US); Christopher N. Japp, Milwaukee, WI (US); Douglas E. Stern, Waukesha, WI (US)

Correspondence Address: Patrick S. Yoder, Suite 330, 7915 FM 1960 West, Houston, TX, 77070, US

(21) Appl. No.: 09/747,661

(22) Filed: Dec. 22, 2000

(51) Int. Cl. G06F 17/60

(52) U.S. Cl. 705/2; 705/7; 705/11

(57) ABSTRACT

The present technique is associated with performance analysis of a medical resource at a medical facility. The technique allows a client to interact with a remote performance analysis system via a network interface, and to enter and transmit client data to the performance analysis system for a performance analysis of the medical resource. Accordingly, the client receives a customized performance analysis of the medical resource.

### FIELD OF THE INVENTION

The present invention relates generally to performance analysis systems and, more particularly, to a technique for analyzing productivity of medical resources for a medical facility. The present technique permits data exchange between a productivity analysis system and a remote interface via a network, allowing a client to interact with the productivity analysis system and to receive productivity analysis of a medical system based on client data.

### BACKGROUND OF THE INVENTION

Medical institutions require various medical resources, such as real estate, human resources, medical systems, equipment and instruments, to provide healthcare services to patients. The medical resources employed at a particular medical institution greatly impact the efficiency, cost and revenue associated with a desired medical procedure. For example, a current system may allow a procedure to be completed in 20 minutes with 10 minutes of setup time, while another system may complete the procedure in 10 minutes with only 2 minutes of setup time. Less time means more procedures, and thus more revenue and lower patient waiting time for the procedures. As medical technology advances, particularly in the area of electronics and computer aided instruments, medical institutions must evaluate the feasibility of investing in new, additional or upgraded medical resources to better serve patients and become more efficient and profitable.

For example, medical diagnostic and imaging systems are ubiquitous in modern health care facilities. Such systems provide invaluable tools for identifying, diagnosing and treating physical conditions and greatly reduce the need for surgical diagnostic intervention. In many instances, final diagnosis and treatment proceed only after an attending physician or radiologist has complemented conventional examinations with detailed images of relevant areas and tissues via one or more imaging modalities.

Currently, a number of modalities exist for medical diagnostic and imaging systems. These include computed tomography (CT) systems, x-ray systems (including both conventional and digital or digitized imaging systems), magnetic resonance (MR) systems, positron emission tomography (PET) systems, ultrasound systems, nuclear medicine systems, and so forth. In many instances, these modalities complement one another and offer the physician a range of techniques for imaging particular types of tissue, organs, physiological systems, and so forth. Health care institutions often dispose of several such imaging systems at a single or multiple facilities, permitting its physicians to draw upon such resources as required by particular patient needs.

Modern medical diagnostic systems typically include circuitry for acquiring image data and for transforming the data into a useable form which is then processed to create a reconstructed image of features of interest within the patient. The image data acquisition and processing circuitry is often referred to as a “scanner” regardless of the modality, because some sort of physical or electronic scanning often occurs in the imaging process. The particular components of the system and related circuitry, of course, differ greatly between modalities due to their different physics and data processing requirements.

Medical diagnostic systems of the type described above are often called upon to produce reliable and understandable images within demanding schedules and over a considerable useful life. To ensure proper operation, the systems are serviced regularly by highly trained personnel who address imaging problems, configure and calibrate the systems, and perform periodic system checks and software updates. However, medical resources such as the above systems may become outdated, or relatively inefficient and costly compared to current medical systems.

Accordingly, a medical institution may desire an upgraded medical system, or other new medical resources, such as medical products, systems and services offered by a medical resource supplier. Unfortunately, a client may not fully appreciate the potential impact a new system could have on operational performance, efficiency and finances of the medical institution. Although manufacturers often provide standard performance indicators for a product, these indicators may not accurately project performance results for a particular institution. For example, each institution may utilize the product in a different way, and have different operating conditions affecting the use of the product. In the medical field, operating conditions may significantly vary from one medical institution to another.

Accordingly, there is a need for a technique for analyzing performance of a medical resource for a medical institution based on client data from the medical institution, and for providing a performance analysis tailored to the client data. More particularly, there is a need for a productivity analysis system allowing interactive exchange of information, such as client data, between a remote client interface and the productivity analysis system via a network. For example, the client data may include operating data for the medical institution or the medical resource. Moreover, there is a need for a productivity analysis system, which compares a plurality of medical resources based on the operating data. For example, a comparison between an existing system and a potential upgraded system would be particularly advantageous.

### SUMMARY OF THE INVENTION

The present technique is associated with performance analysis of a medical resource at a medical facility. The technique allows a client to interact with a remote performance analysis system via a network interface, and to enter and transmit client data to the performance analysis system for a performance analysis of the medical resource. Accordingly, the client receives the performance analysis, which is tailored to the client data for the medical facility, and is allowed to personally evaluate performance indicators for the medical resource at the medical facility.

According to one aspect of the present technique, a method may be provided for analyzing productivity of a medical resource. The method comprises electronically directing client data transmitted from a remote interface to a productivity analysis system via a network, and analyzing the client data with the productivity analysis system. The client data comprises operational data relating to a medical system employed at a medical facility. The method also comprises providing a productivity analysis report to a client via the network.

According to another aspect of the present technique, a system may be provided for analyzing productivity of a medical resource. The system comprises a productivity analysis system and a remote interface configured for exchanging information with the productivity analysis system via a network. The remote interface has a form for transmitting client data, such as medical procedure data associated with a medical system, to the productivity analysis system. The productivity analysis system is configured to generate a productivity report for a medical client based on the client data.

### BRIEF DESCRIPTION OF THE DRAWINGS

The foregoing and other advantages of the invention will become apparent upon reading the following detailed description with reference to the drawings in which:

FIG. 1 is a diagram of the present technique, illustrating an exemplary system for communication and data exchange between a plurality of medical clients and a data processing center remote from the medical clients;

FIG. 2 is a diagram of the present technique, illustrating an exemplary embodiment of the data processing center and data exchange between the data processing center and a client;

FIG. 3 is an exemplary flow chart of the present technique, with reference to the network interface pages of FIGS. 4, 5 and 6;

FIG. 4 is an exemplary query form for entering and transmitting client information from the client to the data processing center;

FIG. 5 is an exemplary results page for graphically displaying medical resource performance analysis results received by the client from the data processing center; and

FIG. 6 is an exemplary results page for textually displaying medical resource performance analysis results received by the client from the data processing center.

### DETAILED DESCRIPTION OF THE INVENTION

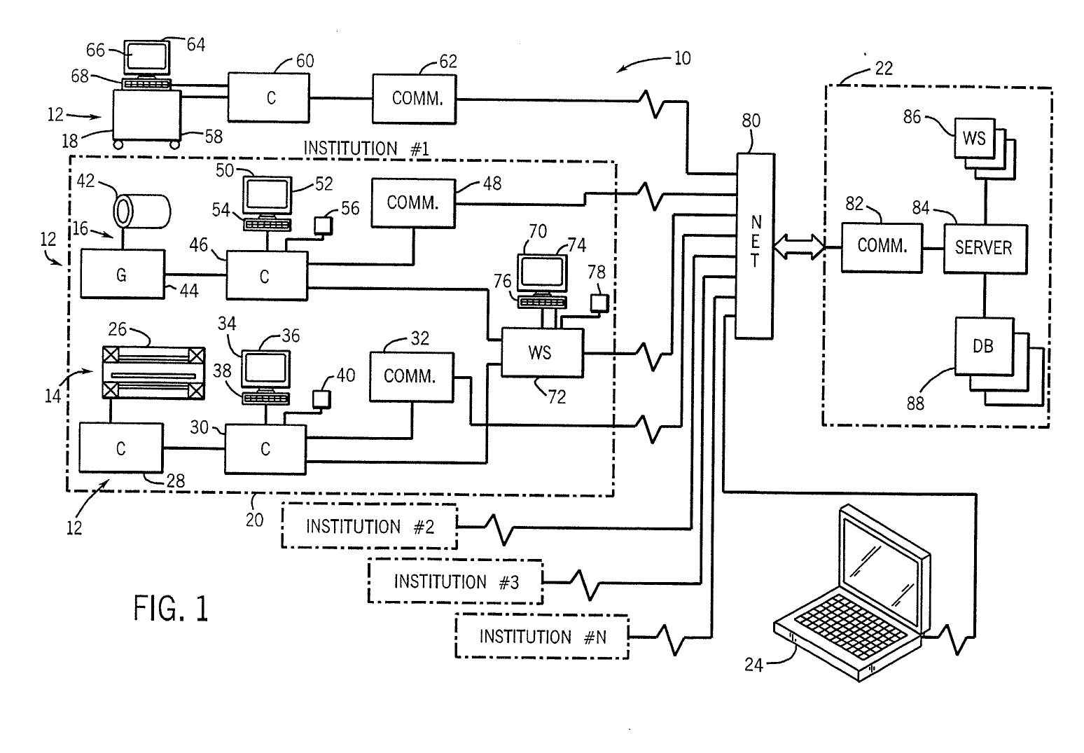

Turning now to the drawings, and referring first to FIG. 1, a communication system 10 is illustrated for providing remote data processing for a plurality of healthcare providers having a plurality of medical resources, such as medical diagnostic systems 12. In the embodiment illustrated in FIG. 1, the medical diagnostic systems 12 include a magnetic resonance imaging (MRI) system 14, a computed tomography (CT) system 16, and an ultrasound imaging system 18. The diagnostic systems 12 may be positioned in a single location or facility, such as institutions #1, #2, #3 and #N (e.g., medical facility 20), or may be remote from one another as illustrated for ultrasound imaging system 18. Each medical facility also may gain remote access to a data processing center 22 via the communication system 10. The data processing center 22 is also accessible via a remote client unit 24. Accordingly, multiple client workstations and medical institutions with various modalities have access to the data processing center 22.

In the exemplary embodiment of FIG. 1, several different medical clients (e.g., institutions #1, #2, #3 and #N) are provided with remote access to the data processing center 22. These and other medical clients may be provided access to, and benefit from, the data processing center 22, depending upon the capabilities of the data processing center 22, and other factors. However, the present technique is particularly well suited for remotely processing client data associated with a wide variety of medical diagnostic system modalities, including MRI systems, CT systems, ultrasound systems, positron emission tomography (PET) systems, nuclear medicine systems, and so forth. Moreover, the medical clients utilizing the data processing center 22 in accordance with the present techniques may be in different medical fields, may have different medical resources, and may have different types of patients. For example, medical resources may include a variety of medical equipment, systems, instruments and human resources for a particular medical procedure or medical practice. Furthermore, medical resources may include real estate, office space, healthcare service capacity, and financial resources of a particular institution. A variety of client data may be transmitted to the data processing center 22 via the communication system 10. For example, the client may transmit data from the medical diagnostic systems, data files from a computer, or data may be entered from a client computer coupled to the communication system 10 (e.g., remote client unit 24). The client data may comprise a variety of information associated with the client, the particular medical institution, and with the medical resources available to the particular medical institution. For example, the client data may comprise past and projected financial data/statistics, operational data/statistics, medical resources used or desired by the client, patient information, and other relevant client data from past operations or future projections.

The medical resources, as noted above, may comprise a variety of medical systems. Depending upon the modality of the systems, various subcomponents or subsystems will be included. In the case of MRI system 14, such systems will generally include a scanner 26 for generating pulsed magnetic fields and for collecting signals from emissions by gyromagnetic material within a subject of interest. The scanner is coupled to a control and signal detection circuit 28 which, in turn, is coupled to a system controller 30. The system controller 30 includes a uniform platform for interactively exchanging client data and processing requests with data processing center 22, as described more fully below. The system controller 30 is linked to a communications module 32, which may be included in a single or separate physical package from system controller 30. System controller 30 is also linked to an operator station 34, which will typically include a computer monitor 36, a keyboard 38, as well as other input devices 40, such as a mouse. In a typical system, additional components may be included in system 14, such as a printer or photographic system for producing reconstructed images based upon data collected from scanner 14. Although reference is made herein generally to “scanners” in diagnostic systems, that term should be understood to include medical diagnostic data acquisition equipment generally. Accordingly, it should not be limited to image data acquisition, to picture archiving communications and retrieval systems, nor to image management systems, facility or institution management systems, viewing systems and the like, in the field of medical diagnostics. More particularly, the medical resources may include imaging systems, clinical diagnostic systems, physiological monitoring systems, and so forth.

Similarly, CT system 16 will typically include a scanner 42, which detects portions of x-ray radiation directed through a subject of interest. Scanner 42 is coupled to a generator and controller, as well as to a signal acquisition unit, represented collectively at reference numeral 44, for controlling operation of an x-ray source and gantry within scanner 42, and for receiving signals produced by a detector array moveable within the scanner. The circuitry within the controller and signal acquisition components is coupled to a system controller 46 which, like controller 30 mentioned above, includes circuitry for commanding operation of the scanner and for processing and reconstructing image data based upon the acquired signals. System controller 46 is linked to a communications module 48, generally similar to communications module 32 of MRI system 14, for transmitting and receiving data for processing at the data processing center 22. Also, the system controller 46 is coupled to an operator station 50, which includes a computer monitor 52, a keyboard 54, as well as other input devices 56, such as a mouse. Moreover, like MRI system 14, CT system 16 will generally include a printer or similar device for outputting reconstructed images based upon data collected by scanner 42.

Other modality devices will include circuitry and hardware particularly configured for acquiring or producing signals in accordance with their particular design. In particular, in the case of ultrasound system 18, such systems will generally include a scanner and data processing unit 58 for transmitting ultrasound signals into a subject of interest, and for acquiring resultant signals which are processed for reconstructing a useful image. The system includes a system controller 60 which regulates operation of scanner 58 and which processes acquired signals to reconstruct the image. Moreover, system 18 includes a communications module 62 for transmitting client data and processing requests between system controller 60 and the data processing center 22. System 18 also includes an operators station 64, including a monitor 66, as well as input devices such as a keyboard 68.

Where more than one medical diagnostic system is provided in a single facility or location, as indicated in the case of MRI and CT systems 14 and 16 in FIG. 1, these may be coupled to a management station 70, such as in a radiology department of a hospital or clinic. The management station may be linked directly to controllers for the various diagnostic systems, such as controllers 30 and 46 in the illustrated embodiment. The management system may include a computer workstation or personal computer 72 coupled to the system controllers in an Intranet configuration, in a file sharing configuration, a client/server arrangement, or in any other suitable manner. Moreover, management station 70 will typically include a monitor 74 for viewing system operational parameters, analyzing system utilization, and exchanging client data and processing information between the facility 20 and the data processing center 22. Input devices, such as a standard computer keyboard 76 and mouse 78, may also be provided to facilitate the user interface. It should be noted that, alternatively, the management system, or other diagnostic system components, may be “stand-alone” or not coupled directly to a diagnostic system. Although the data processing center 22 may require a variety of client data to fully process a client request, the client data may not include medical system data derived directly from the medical system (e.g., CT and MRI systems). The client data may simply be transmitted from a client computer (e.g., remote client unit 24) after having been entered by the medical client. For example, the client data may be entered via an electronic form, or web interface.

The communication modules mentioned above, as well as workstation 72 and remote client unit 24, may be linked to data processing center 22 via a remote access network 80. For this purpose, any suitable network connection may be employed. Presently preferred network configurations include both proprietary or dedicated networks, as well as open networks, such as the Internet. Data may be exchanged between the institutions, medical resources, client computers and the remote data processing center 22 in any suitable format, such as in accordance with the Internet Protocol (IP), the Transmission Control Protocol (TCP), or other known protocols. Moreover, certain portions of the data may be transmitted or formatted via markup languages such as the HyperText Markup Language (HTML), Extensible Markup Language (XML), or other Internet and communication languages. Exemplary interface structures and communications components are described in detail below.

Within the data processing center 22, messages, client requests and client data are received by communication components as indicated generally at reference numeral 82. The communication components 82 direct the client data to a server, or a processing system 84, for the receipt, handling and processing of client data. In general, processing system 84 may include one or a plurality of computers, as well as dedicated hardware or software servers for processing the various requests and for receiving and transmitting the information as described more fully below. The data processing center 22 also may include a bank of workstations 86, which may be staffed by operators who address the processing requests and provide off and on-line assistance in response to the processing requests. Also, the processing system 84 may be linked to a set of databases or other processing systems 88 at or remote from the data processing center 22. Such databases and processing systems may include extensive database information on medical resources (e.g., medical systems), a particular medical facility, and so forth. As described below, such databases may be employed both for analyzing the client data and for processing the request transmitted by the client.

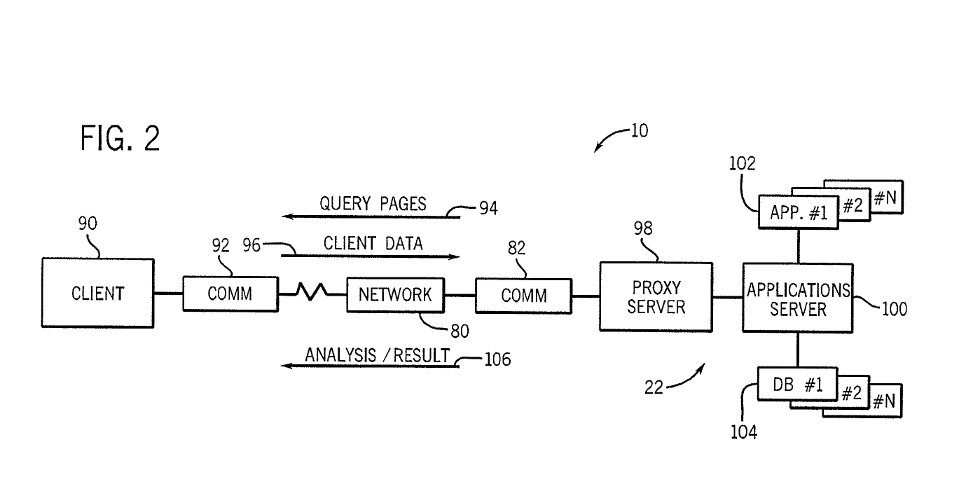

FIG. 2 is a diagram of the communication system 10, illustrating an exemplary embodiment of the data processing center 22 accessible by a client 90. The client 90 may be a medical facility, institution or individual interested in medical resources. The data processing center 22 may be associated with a medical supplier, a medical institution, or some other entity located remote from the client 90. For example, the data processing center 22 may be associated with a consulting firm, or some other performance/productivity management firm. The client 90 can communicate with the data processing center 22 via a communication device 92, which connects to the network 80 and the communication components 82 for the data processing center 22. The communication device 92 may be a modem or some other network device, allowing the client 90 to connect to the network 80 with a client computer system (e.g., remote client unit 24). The client 90 may access the network 80 via the Internet or other suitable network connections, thus the network 80 can be broadly interpreted to comprise all necessary networking between the client 90 and the data processing center 22.

In this exemplary embodiment, the client 90 electronically receives request pages 94 (e.g., data entry forms) from the data processing center 22, or an applications server for the network (e.g., Internet). For example, the client 90 may go to a web site having the request pages. The client 90 enters data, makes appropriate selections, and transmits a processing request to the data processing center 22. Accordingly, client data 96 is routed through the network 80 and to the data processing center 22, which may include a plurality of computer systems, servers, workstations, databases, and other hardware and software applications necessary for processing the client data. The client data 96 is received by a server (e.g., proxy server 98), which handles the request and directs the client data to the appropriate processing components, such as an applications server 100.

In this exemplary embodiment, the applications server 100 has appropriate applications 102 (e.g., application #1, #2 and #N) and databases 104 (e.g., database #1, #2, and #N) for analyzing the client data. Accordingly, a medical resource productivity optimizer program (e.g., a resource optimizer tool) may be disposed on the applications server 100 with one or more medical resource databases, wherein the optimizer program is configured to search the databases for a desired medical and utilize resource specifications (e.g., setup time, power consumption, costs, medical procedures provided by the system, and a variety of other performance and operating characteristics) along with a variety of client input (e.g., operational criteria at a medical facility) to evaluate one or more medical resources. The applications server 100 may comprise a plurality of computer systems networked together, and may have one or more remote computer systems for a particular application. For example, a special application may be provided by a separate entity under a licensing agreement. Moreover, a portion of the applications 102 may be disposed on a web server. For example, the resource optimizer program may embody an Internet based optimizer tool configured to compare one or more medical resources for a medical client, who may be contemplating upgrading an existing medical resource to an upgraded medical resource.

The applications server 100 and corresponding applications 102 and databases 104 collectively generate an analysis tailored to the client data 96, and provide a customized analysis report for the client 90 based on the client data 96. For example, the customized analysis report may provide medical facility operational information (e.g., patient statistics, capacity of facility, experience levels of doctors and technicians, types of procedures offered at the facility, etc.), which may impact the performance analysis of medical resources (e.g., CT and MRI systems). The analysis and results 106 are then transmitted to the client 90 via the communication system 10. The results 106 may be formatted by the applications server 100, or transmitted as unformatted data for subsequent formatting by a client server or web server. For example, the data processing center 22 may generate user viewable pages (e.g., Internet pages) based on the analysis. The client may then view the pages via a network interface, which may comprise a client computer system having an Internet browser or other appropriate software.

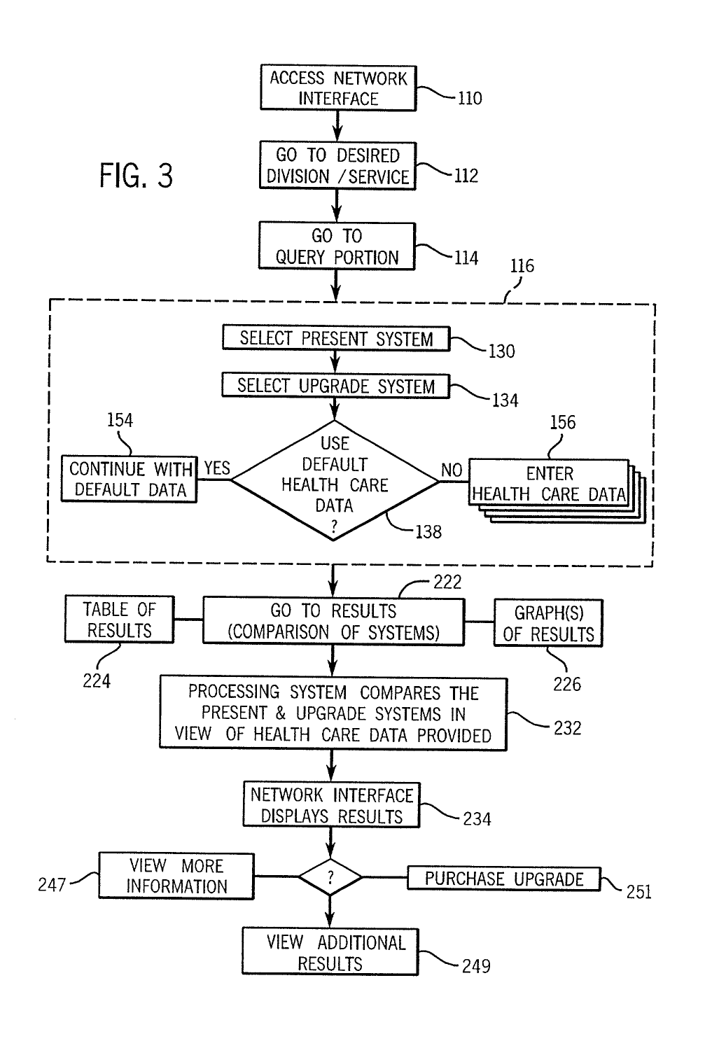

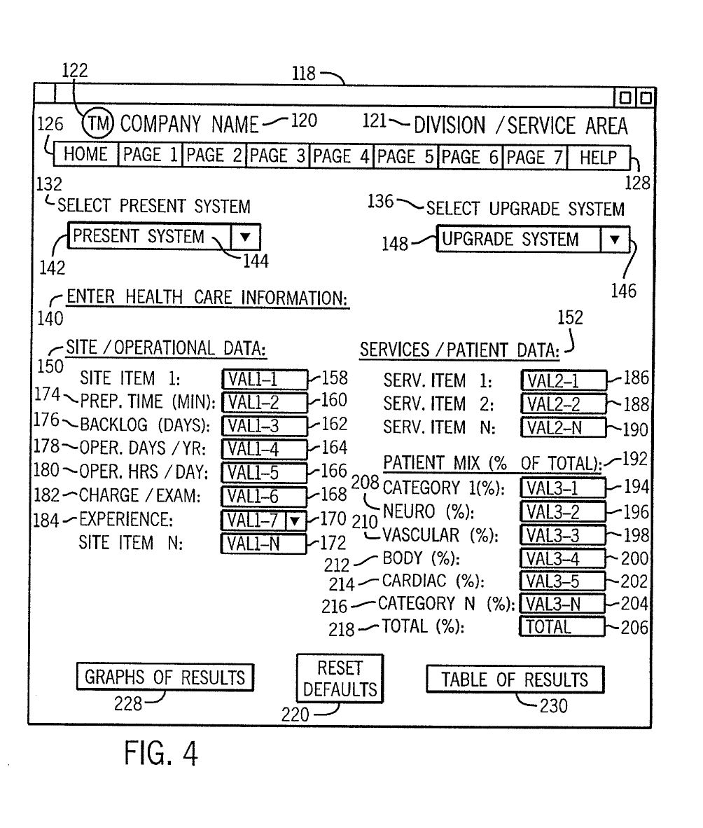

FIG. 3 is a diagram of the present technique, illustrating communication and data exchange between the client 90 and the data processing center 22 remote from the client 90. To communicate with the data processing center 22, the client 90 accesses the network interface 110, which may include a variety of hardware and software such as a server, a client computer system and communication software. In this exemplary embodiment, the network interface comprises electronic forms, such as illustrated in FIG. 4, allowing the client 90 to enter and transmit client data to the data processing center 22. For example, the network interface may be configured to access and display an Internet site (e.g., a website), requiring the client 90 to gain access to the website to view and browse the electronic forms. Accordingly, the network interface may comprise an Internet browser (e.g., Netscape or MS Internet Explorer) or other suitable software for displaying the electronic forms, provided that it allows the client 90 to transmit client data to the data processing center 22. Once the client 90 has access to the network interface, which may require a password and other login information, the client 90 may go to or browse to the desired division or service 112 displayable via the network interface. For example, if the network interface comprises an Internet website, the client 90 may browse the website and go to a page displaying the desired division or service 112. The division or service may be a financial service, a productivity service, or it may be a service associated with a particular medical resource. In the present technique, the client browses to a performance/productivity service area, and goes to a query portion 114 of that performance area. For example, the client 90 may go to a query section 116, such as query form 118 illustrated in FIG. 4, where a variety of questions are provided regarding the client 90 and the medical facility and/or resources associated with the client 90.

In the present technique, the questions on the query form 118 are tailored to obtain a variety of client data, which may be relevant to a productivity analysis of medical resources (e.g., a medical product or system). Accordingly, the electronic forms may inquire into various matters that are relevant to using the medical resources and to operations at the medical facility (e.g., patient statistics, capacity of facility, experience levels of doctors and technicians, types of procedures offered at the facility, setup time, procedure time, financial data, etc.), which may impact the performance evaluation of the particular medical resources. Furthermore, the query form 118 may be tailored to the client 90, or it may allow the client 90 to enter client specific categories and data, rather than the queries illustrated in FIG. 4. In one aspect, the present technique comprises an optimizer tool, which may be utilized by the client 90 to obtain a customized medical resource performance analysis based on the client data. An exemplary embodiment of this optimizer tool utilizes the Internet, and provides an Internet based optimizer tool for medical clients to evaluate performance of one or more medical resource and/or compare performance criteria between an existing medical resource and a potential upgraded medical resource.

Referring now to FIG. 4, the query form 118 as illustrated has a header area providing a company name 120, a trademark for the company 122, a division and service area 124, and a plurality of links to pages such as a home page 126, a page 1, a page 2, a page 3, a page 4, a page 5, a page 6, a page 7, and a help page 128. The division or service area 124 may be listed as a performance evaluation service such as a medical resource performance evaluation. In order for the data processing center 22 to accurately evaluate the performance or productivity of a particular medical resource, the client 90 may enter a plurality of client data associated with the particular medical resource. In the query section 116 of the query form 118, the client 90 may select a present system 130 in a Select Present System section 132, select an upgrade system 134 in a Select Upgrade System section 136, and may have options 138 regarding entering healthcare information 140.

In the Select Present System section 132, the client 90 may select a medical resource system, such as a present system 144, from a drop-down menu 142. In the select upgrade system 136, the client 90 may be allowed to select a medical resource system, such as an upgrade system 148, from a drop-down menu 146. The medical resource systems, as noted above, may comprise CT systems, MRI systems, and a variety of other systems and options, accessories and services provided in conjunction with those systems. In the Enter-Healthcare Information section 140, the client 90 may enter a plurality of healthcare information associated with the client 90 and the medical institution or facility of the client 90.

For example, the client 90 may enter a plurality of information in a Site/Operational Data section 150 and/or in a Services/Patient Data section 152. However, the client 90 has the option 138 of proceeding with default healthcare data rather than entering data, if the client 90 desires a quick evaluation of the medical resource(s) or simply does not have information to enter into the sections 150 and 152. Accordingly, the client 90 may continue with default data 154 or enter healthcare data 156 under the categories 150 and 152. In the Site/Operational Data section 150, the query form 118 provides text boxes 158, 160, 162, 164, 166, 168, a drop-down menu 170, and a text box 172 for entering client data for a site item 1, a preparation time 174, a back log time 176, an operation time 178 in days per year, an operation time 180 in hours per day, a charge per exam 182, an experience level 184, and a site item N, which may have data entries of VAL1-1, VAL1-2, VAL1-3, VAL1-4, VAL1-5, VAL1-6, VAL1-7, and VAL1-N, respectively. The preparation time 174 may be listed in minutes or in other time measurements, and may refer to the setup time required by an operator to prepare for use of one of the medical resource systems as selected in the drop-down menu 142. The back log time 176 refers to the time (e.g., days) that the facility is behind in providing medical procedures with the present system, as selected in the drop-down menu 142. The operating times 178 and 180 refer to the time that the site or medical facility operates over the year. The experience level 184 refers to the experience level of an operator of the present system selected in the drop-down menu 142, such as inexperienced, average experience, advanced experience, or any other relevant experience level.

In the Services/Patient Data section 152, text boxes 186, 188, and 190 are provided for entering a service item, a service item 2, and a service item N, allowing entries such as VAL2-1, VAL2-2, and VAL2-N, respectively. These service items may comprise a variety of factors relevant to the evaluation of the performance of the present system and/or the upgrade system selected in the drop-down menus 142 and 146, respectively. For example, the service items may relate to an age category of patients, an income level of patients, a payor type for services rendered, and a variety of medical history for patients of the client 90. The Services/Patient Data section 152 may also have a Patient Mix section 192, having text boxes 194, 196, 198, 200, 202, 204, and 206 for entering a percentage of patients in a plurality of categories, such as a category 1, a neuro category 208, a vascular category 210, a body category 212, a cardiac category 214, a category N (216), and a total for the categories 218, respectively. For example, values of VAL3-1, VAL3-2, VAL3-3, VAL3-4, VAL3-5, VAL3-N, and TOTAL may be entered into text boxes 194 through 206, indicating relative numbers or proportions of each type of patient serviced by the client 90. Accordingly, the patient mix section 192 allows the data processing center 22 to evaluate and compare the present and upgrade medical resource systems selected in drop-down menu 142 and 146, respectively, according to the types of patients that frequent the medical facility of the client 90. For example, the upgrade system, as selected in the drop-down menu 146, may provide additional healthcare services or medical procedures which the present system lacks. Also, the upgrade system may provide medical procedures more efficiently than the present system for one or more of the categories in the Patient Mix section 192. If the client 90 makes a mistake, or simply wishes to restore the default values for the healthcare information 140, then the client 90 may simply click on a Reset Defaults button 220. Otherwise, the client 90 may continue to the results for comparison of systems 222, which may comprise a table of results 224 and/or a graph(s) of results 226, by clicking on a Graph Of Results button 228 or a Table Of Results button 230, respectively.

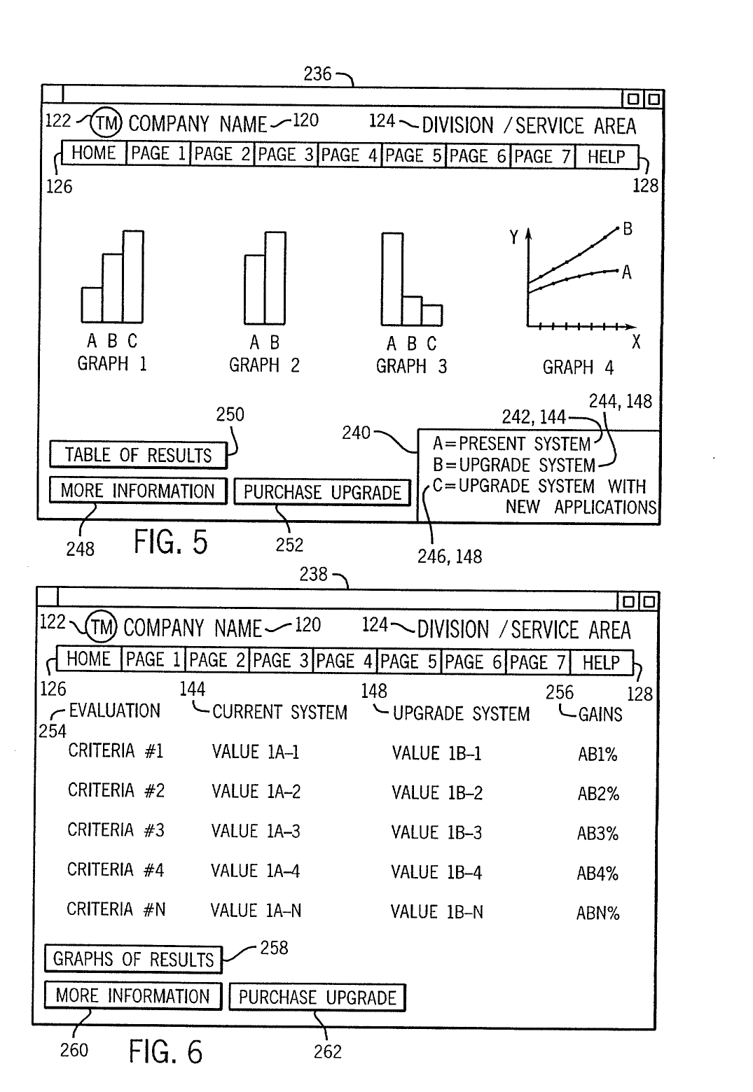

Once the client 90 clicks on the Graph Of Results button 228 or the Table Of Results button 230, the client data entered or selected on the query form 118 is transmitted to the data processing center 22, where the processing system compares the present and upgrade systems in view of the healthcare data provided 232. At the data processing center 22, the client data may be evaluated by one or more applications 102 utilizing one or more databases 104, such that the present system 144 and the upgrade system 148 are compared according to the client data and specific medical resource specifications for those systems. The data processing center 22 then transmits the performance analysis, either as formatted or unformatted data, to the network interface for display of the results 234. If the client 90 clicked on the Graph Of Results button 228, then the client 90 is directed to a results page 236 as illustrated in FIG. 5. If the client 90 clicked on the table of results button 230, then the client 90 is directed to a results page 238 as illustrated in FIG. 6.

The results page 236 has one or more performance or productivity graphs comparing the present and upgrade systems 144 and 148, such as a graph 1, a graph 2, a graph 3, and a graph 4. A legend 240 is also provided for the graphs 1 through 4. As illustrated, the graphs may provide three comparisons between the medical resource systems, such as a present system 242 labeled as A, an upgrade system 244 labeled as B, and the upgrade system with new applications 246 labeled as C (e.g., as indicated in the graphs 1 and 3). The upgrade system with new applications may simply be the same upgrade system as B, but illustrated with the additional procedures available with the upgrade system. Otherwise, the upgrade system C may be an entirely different upgrade system, or the same core upgrade system with additional features, options and accessories. The performance criteria may be displayed in a variety of graphical illustrations, such as bar charts (e.g., graphs 1, 2, and 3) or line graph (e.g., graph 4). The graphs 1 through 4 may evaluate performance and productivity between the present system and upgrade system according to a variety of performance or productivity criteria, such as back log time, revenues, actual patients per day, a time for completing an exam using the medical resource system, or a projected growth of exams (e.g., medical services and procedures) for each of the systems. Also, if the upgrade system has additional applications, as with the upgrade system with new applications 246 (e.g., legend item C), the graphs may indicate a substantially different performance level depending on the particular performance criteria evaluated in the graph. For example, if one of the graphs evaluates revenue opportunity, then the upgrade system with new applications 246 may perform significantly better (e.g., higher revenue opportunity) than both the present system 242 and the upgrade system 244. The client 90 may also be allowed to select specific types of system comparisons in the query form 118, such that the client 90 may be required to enter in specific information relating to those evaluation criteria (e.g., a financial criteria may require certain client financial data). If the client 90 desires additional information 247 regarding the upgrade system, then a more information button 248 may be pressed to take the client 90 to an information page. The client 90 may also view additional results 249 by depressing a Table Of Results button 250, which directs the client 90 to the results page 238, as illustrated in FIG. 6. Also, the client 90 may purchase an upgrade 251 by depressing a Purchase Upgrade button 252, which may take the client 90 to a purchase transaction page for purchasing the desired medical resource, such as the upgrade system 148 selected in the query form 118.

If the client 90 clicked on the Table Of Results button 250, then the client 90 is directed to the results page 238, which provides a plurality of evaluation criteria 254 such as a criteria #1, a criteria #2, a criteria #3, a criteria #4, a criteria #N for the current system 144 and upgrade system 148 selected from the drop-down menus 142 and 146, respectively. For example, the current system 144 may have evaluation criteria values of VALUE 1A-1 through VALUE 1A-N while the upgrade system 148 may have values of VALUE 1B-1 through VALUE 1B-N for evaluation criteria #1 through N, respectively. Based on these criteria values, gains 256 of AB1% through ABN% are shown for criteria #1 through N for a gain that the upgrade system 148 has over the current system 144 for the evaluation criteria 254. As discussed for FIG. 5, the evaluation criteria 254 may comprise a back log time, a revenue opportunity, a minutes per exam, an actual patients per day, or a variety of other performance and productivity evaluation criteria between the medical resources (e.g., the present and upgrade systems). Once the client 90 has viewed the results on the results page 238, the client 90 may click on a button 258 to view graphs of the results, click a More Information button 260 to learn more about the upgrade system, or click on a Purchase Upgrade button 262 in order to continue on with a purchase transaction for the upgrade system.

According to the embodiments illustrated in FIGS. 1-6, the present technique provides an exemplary method for analyzing productivity of a medical resource. Accordingly, the present technique may comprise electronically directing client data transmitted from a remote interface to a productivity analysis system via a network, analyzing the client data with the productivity analysis system, and providing a productivity analysis report of the medical resource to a client via the network.

The present technique also may include providing the remote interface (e.g., the network interface). The method may also involve identifying the client and tailoring the remote interface to the client (e.g., through a login and password, and a client profile stored for the client 90). Accordingly, a variety of hardware and software may be provided and/or configured for the productivity analysis system, such as a client computer system, an applications server, a web server, databases, communications software, a web browser, a website, electronic forms, Internet forms, Internet pages, and/or a private network interface accessible via a dialup account or other networking. For example, the present technique may comprise setting up, and/or receiving client data from, a plurality of Internet forms having data entry fields (e.g., text boxes, drop-down menus, check boxes, buttons, etc.). In this exemplary embodiment the data entry fields and/or client data may comprise a variety of information categories relevant to evaluating the medical resource, as discussed below.

For example, the present technique may comprise allowing data entry, formatting client requests, formatting data for transmitting, directing the client data and requests, transmitting the client data, and receiving the client data and requests at the productivity analysis system (e.g., the data processing center 22). For example, these characteristics may apply to the following client data: a selection of one or more medical resources from a plurality of medical resources (e.g., modalities or medical imaging systems), a medical system employed at the medical facility, an upgrade medical system for productivity comparison with the medical system employed at the medical facility, operational data relating to a medical system employed at a medical facility, medical procedure statistics at least partially relating to the medical system, volume data relating to medical procedures employing the medical system, time data relating to the medical procedures, revenue data relating to the medical procedures, an operator experience level relating to the medical procedures, a mix of medical procedures provided at the medical facility, among other client data relevant to the productivity analysis.

The present technique may also comprise searching a medical resource database, and accessing medical system statistics for the medical resource(s) selected for productivity analysis. The method may also comprise providing, directing and/or transmitting a variety of productivity analysis reports, and formats for presenting the reports, to the client 90. Accordingly, this may involve providing a procedure efficiency analysis, or a productivity comparison between the medical system and at least one other medical system to allow the client to evaluate benefits of a system upgrade to the at least one other medical system. The method may also involve providing at least one indicator of new procedures provided by the at least one other medical system, and evaluating the impact of the new procedures. Moreover, the productivity analysis system may transmit performance information to the remote interface for display to the client 90 (e.g., an Internet document). The method may also provide the client with an option to purchase the medical system and/or the at least one other medical system.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for analyzing productivity of a medical resource, the method comprising:
electronically directing client data transmitted from a remote interface to a productivity analysis system via a network, wherein the productivity analysis system is configured to evaluate a plurality of medical resources associated with at least one of a plurality of modalities, the client data comprising operational data relating to a medical system employed at a medical facility;
analyzing the client data with the productivity analysis system; and
providing a productivity analysis report to a client via the network, the productivity analysis report allowing the client to evaluate medical resource productivity at the medical facility.

2. The method of claim 1, wherein electronically directing via the network comprises electronically directing via the Internet.

3. The method of claim 1, comprising providing the remote interface with a form for entering the client data.

4. The method of claim 1, comprising providing a form field for selecting the medical system employed at the medical facility.

5. The method of claim 3, comprising allowing selection of multiple medical systems for productivity comparison.

6. The method of claim 4, comprising providing a form field for selecting an upgrade medical system for productivity comparison with the medical system employed at the medical facility.

6. The method of claim 3, comprising providing a form field for entering volume data relating to medical procedures employing the medical system at the medical facility.

7. The method of claim 3, comprising providing a form field for entering time data relating to medical procedures employing the medical system at the medical facility.

8. The method of claim 3, comprising providing a form field for entering revenue data relating to medical procedures employing the medical system at the medical facility.

9. The method of claim 3, comprising providing a form field for entering an operator experience level relating to medical procedures employing the medical system at the medical facility.

10. The method of claim 1, comprising receiving a selection of at least one medical system from a plurality of medical systems comprising multiple medical imaging systems.

11. The method of claim 1, comprising receiving medical procedure statistics of the medical facility, the medical procedure statistics at least partially relating to the medical system.

12. The method of claim 11, wherein receiving medical procedure statistics comprises receiving a mix of medical procedures provided at the medical facility.

13. The method of claim 1, wherein analyzing the client data comprises searching a medical resource database, and accessing medical system statistics.

14. The method of claim 13, wherein accessing medical system statistics comprises accessing medical system statistics for a plurality of medical systems for productivity comparison with the productivity analysis system.

15. The method of claim 1, wherein providing the productivity analysis report comprises providing a procedure efficiency analysis of the medical system for display via the remote interface.

16. The method of claim 1, wherein providing the productivity analysis report comprises providing a productivity comparison between the medical system and at least one other medical system, the productivity comparison allowing the client to evaluate benefits of a system upgrade to the at least one other medical system.

17. The method of claim 16, wherein providing the productivity comparison comprises providing at least one indicator of new procedures provided by the at least one other medical system.

18. The method of claim 1, wherein providing the productivity analysis report comprises providing a graphical illustration of the medical resource productivity at the medical facility.

19. A system for analyzing productivity of a medical resource, the system comprising:
a productivity analysis system configured for analyzing productivity of the medical resource; and
a remote interface configured for exchanging information with the productivity analysis system via a network, the remote interface having a form for transmitting client data to the productivity analysis system, the client data comprising medical procedure data associated with a medical system, wherein the productivity analysis system is configured to generate a productivity report from the client data to allow a client to evaluate medical resource productivity at a medical facility.

20. The system of claim 19, wherein the network comprises the Internet.

21. The system of claim 19, wherein the form comprises a field for selecting the medical system employed at the medical facility from a plurality of medical systems comprising a plurality of modalities.

22. The system of claim 19, wherein the form is configured for multiple selections of medical systems for productivity comparison.

23. The system of claim 21, wherein the form comprises a field for selecting an upgrade medical system for productivity comparison with the medical system employed at the medical facility.

24. The system of claim 19, wherein the form comprises fields for entering time and volume data associated with medical procedures employing the medical system at the medical facility.

25. The system of claim 19, wherein the form comprises a field for entering service charges associated with medical procedures employing the medical system at the medical facility.

26. The system of claim 19, wherein the client data comprises a selection of at least one medical system from a plurality of medical systems comprising medical imaging systems.

27. The system of claim 19, wherein the client data comprises a medical procedure mix illustrating proportionality of medical procedures provided by the medical facility.

28. The system of claim 19, comprising a medical resource database having operating statistics for the medical system, the medical resource database being accessible by the productivity analysis system.

29. The system of claim 19, wherein the productivity report comprises a productivity comparison between the medical system and at least one other medical system, the productivity comparison allowing the client to evaluate benefits of a system upgrade to the at least one other medical system.

30. The system of claim 29, wherein the productivity comparison comprises at least one indicator of new procedures provided by the at least one other medical system.

31. A productivity tool for analyzing productivity of a medical resource, the tool comprising:
a productivity analysis system configured for analyzing productivity of the medical resource;
a medical resource database accessible by the productivity analysis system, the medical resource database having operating statistics for a plurality of medical resources; and
a remote interface configured for exchanging information with the productivity analysis system via a network, the remote interface having data entry fields for transmitting client data to the productivity analysis system and having at least one page for displaying a productivity analysis provided by the productivity analysis system, wherein the client data comprises medical procedure statistics associated with a medical system for a medical facility.

32. The productivity tool of claim 31, wherein the remote interface comprises a server to communicate between the remote interface and the productivity analysis system via the network.

33. The productivity tool of claim 31, wherein the data entry fields comprise a field for selecting the medical system employed at the medical facility from a plurality of medical systems comprising a plurality of modalities.

34. The productivity tool of claim 31, wherein the data entry fields are configured for multiple selections of medical systems for productivity comparison.

35. The productivity tool of claim 33, wherein the data entry fields comprise a field for selecting an upgrade medical system for productivity comparison with the medical system employed at the medical facility.

36. The productivity tool of claim 31, wherein the data entry fields comprise fields for entering time and volume data associated with medical procedures employing the medical system at the medical facility.

37. The productivity tool of claim 31, wherein the data entry fields comprise a field for entering a financial statistic associated with medical procedures employing the medical system at the medical facility.

38. The productivity tool of claim 31, wherein the medical procedure statistics comprise a mix of medical procedures provided at the medical facility.

39. The productivity tool of claim 31, wherein the productivity analysis comprises a productivity comparison between the medical system and at least one other medical system, the productivity comparison allowing the client to evaluate benefits of a system upgrade to the at least one other medical system.

40. The productivity tool of claim 39, wherein the productivity comparison comprises at least one indicator of new procedures provided by the at least one other medical system.

41. A method for analyzing productivity of a medical resource, the method comprising:
electronically directing client data from a remote interface to a productivity analysis system via a network, the client data comprising procedure statistics associated with a medical system employed at a medical facility;
analyzing the client data with the productivity analysis system;
generating a productivity analysis comprising a productivity comparison of the medical system and a proposed upgrade system for the medical facility; and
transmitting the productivity analysis to the client via the network.

42. The method of claim 41, wherein electronically directing via the network comprises electronically directing via the Internet.

43. The method of claim 41, comprising providing a form field for selecting the medical system employed at the medical facility from a plurality of medical systems comprising a plurality of modalities.

44. The method of claim 43, comprising allowing selection of multiple medical systems for productivity comparison.

45. The method of claim 41, comprising providing a form field for selecting the proposed upgrade system from a plurality of medical systems comprising a plurality of modalities.

46. The method of claim 41, comprising providing a form field for entering time and volume data relating to medical procedures employing the medical system at the medical facility.

47. The method of claim 41, comprising providing a form field for entering a financial statistic relating to medical procedures employing the medical system at the medical facility.

48. The method of claim 41, comprising receiving the client data at the productivity analysis system.

49. The method of claim 48, wherein receiving the client data comprises receiving a mix of medical procedures provided at the medical facility.

50. The method of claim 41, wherein analyzing the client data comprises searching a medical resource database having operational statistics for a plurality of medical systems.

51. The method of claim 41, wherein generating the productivity analysis comprises providing a productivity comparison between the medical system and a plurality of proposed upgrade systems.

52. The method of claim 41, wherein generating the productivity analysis comprises providing at least one indicator of additional procedures provided by the proposed upgrade system.

53. The method of claim 41, comprising providing an option to purchase the proposed upgrade system.
